(19) United States
(12) Patent Application Publication
(10) Pub. No.: US 2015/0259973 A1
(43) Pub. Date: Sep. 17, 2015

(54) Protective Window Shutter

(71) Applicant: Stephen Beaudoin, Neptune City, NJ (US)

(72) Inventor: Stephen Beaudoin, Neptune City, NJ (US)

(21) Appl. No.: 14/253,255

(22) Filed: Apr. 15, 2014

Related U.S. Application Data
(60) Provisional application No. 61/951,573, filed on Mar. 12, 2014.

(51) Int. Cl. E06B 9/04; E06B 9/24

(52) U.S. Cl. CPC E06B 9/04; E06B 9/24

(57) ABSTRACT

A protective window shutter is designed to cover and uncover a door mounted “peek through” metal framed window. The shutter is made up of two shutter sections, rotatable in relation to each other, The first shutter section is secured adjacent to the window's metal frame and the second shutter section is rotatable from a first position in which the two sections are folded on each other, to a second position in which the second section is extended out from the first section, over the window. The shutter sections are maintained in the closed position by the attraction of metal strike plates on the first shutter section and corresponding magnets encased within the second shutter. The second section is maintained over the window by the attraction of the magnets to the window's metal framing. The shutter sections are made of high strength, lightweight PVC or like material.

### RELATED APPLICATION

The herein application claims the benefit of provisional application Ser. No. 61/951,573, filed on Mar. 12, 2014.

### BACKGROUND OF THE INVENTION

There are many types of shutters designed to cover windows for a variety of purposes. For instance, shutters are routinely utilized for privacy, security, esthetics, control of room lighting, etc. One such purpose which has become increasingly important in today's society is the need to close of “peek through” windows mounted within doors in classrooms, offices, or other interior doors, to ensure safety, privacy, and added security to students, teachers, and others occupying a room. There is a need especially to quickly and efficiently close a shutter over a door mounted window for the safety of educators and students in schools and similar buildings. This capability has value, as well, in other buildings and environments where security and safety are important. While many different types of shutters exist, there are none which can be put in place quickly and efficiently to cover a door mounted window.

### SUMMARY OF THE INVENTION

It is thus the object of the present invention to provide a protective window shutter which has significant advantages over existing shutters.

It is the object of the present invention to provide a unique protective window shutter which addresses the concerns of students, teachers, educators, and others who seek to obtain an element of privacy, security and safety within rooms.

It is a further object of the present invention to provide a protective window shutter which is lightweight, and easy and readily installed on doors having “peek through” windows.

It is a further object of the present invention to provide a protective window shutter which remains unobtrusively in place adjacent to an uncovered window mounted in a door.

It is still another object of the present invention to provide a protective window shutter which is quickly and easily closed to fully cover the window, and then easily returned to the uncovered position adjacent to the window.

It is another object of the present invention to provide a protective window shutter which is made of a high strength, yet lightweight material, capable of functioning properly while still withstanding impact by students or sports equipment in a gymnasium environment.

These and other objects are accomplished by the present invention, a lightweight foldable protective window shutter and shutter system for covering and uncovering a door mounted “peek through” metal framed window which comprises two interconnected shutter sections, rotatable in relation to each other. The first shutter section is secured adjacent to the metal frame of the window and the second shutter section is rotatable from a first closed position in which the two sections are folded on each other, to a second position in which the second section is extended out from the first section, over the window. The shutter sections are maintained in the closed position by the attraction of metal strike plates on the first shutter section and corresponding magnets encased within the second shutter. The second section is maintained over the window by the attraction of the magnets to the metal framing around the window. The shutter sections are made of high strength, yet lightweight PVC or like material, capable of withstanding routine impacts.

### BRIEF DESCRIPTION OF THE DRAWINGS

FIG. 1 shows the protective window shutter in the window uncovered position, adjacent to a metal framed window.

FIG. 2 shows the protective window shutter illustrating the process of covering the window.

FIG. 3 shows the protective window shutter mounted on a door with a peek through framed window, illustrating the process of covering the window.

FIG. 4 shows the continuation of the window covering process shown in FIG. 3.

FIG. 5 shows the protective window shutter in place over the window.

FIG. 6 is a cross-section of the protective window shutter taken from FIG. 2.

### DESCRIPTION OF THE INVENTION

Protective window shutter 1 comprises first elongated shutter section 2 and second elongated shutter section 4. First section 2 has an elongated top layer comprising sheet 3 of high impact, corrugated or equivalent PVC or like lightweight material and a second elongated bottom layer comprising sheet 5 made of the same material. Sheets 3 and 5 extend the full length of section 2 and are separated by a narrow space in which elongated, corrugated PVC strength ribs 7 extend the length of the section. Metal strike plates 6 and 8 are secured at the top and bottom ends of top sheet 3 of first section 2.

Second section 4, made of the same material as first section 2, is positioned adjacent to the first section and is formed with the same elongated top sheet 3 as the first section. This top sheet 3 extends the full width of shutter 1, from the outboard edge of first section 2 to the outboard edge of second section 4, and the full length of both sections, from their top edges to their bottom edges.

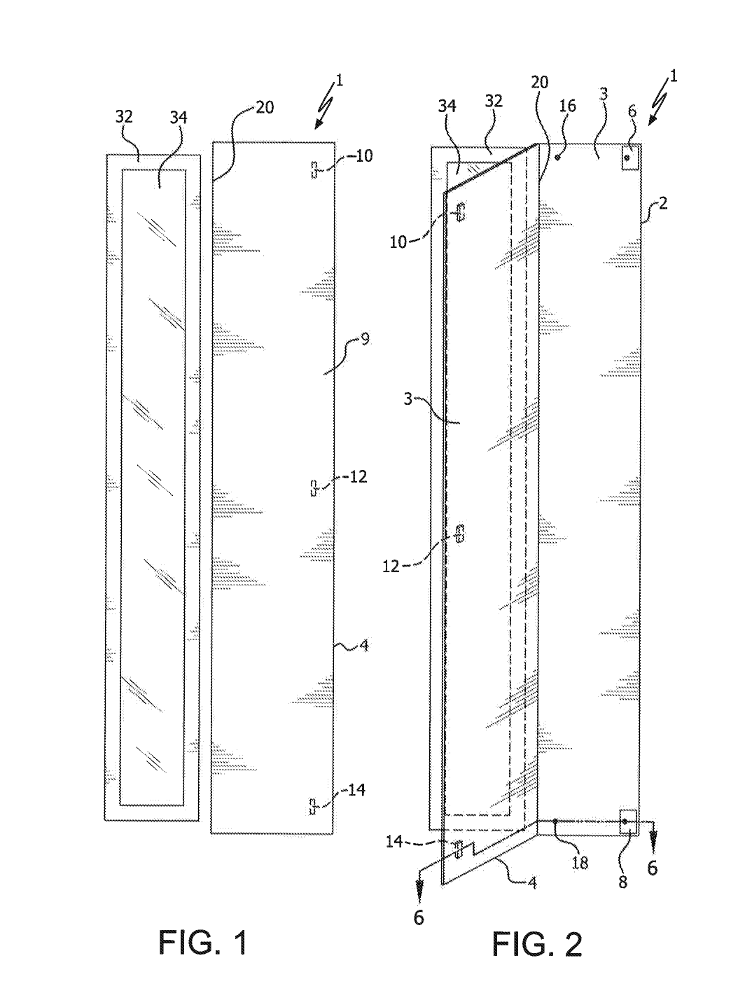

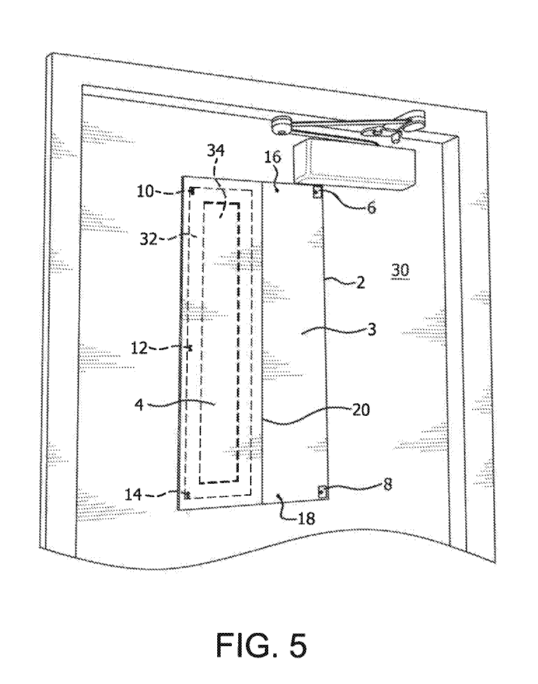

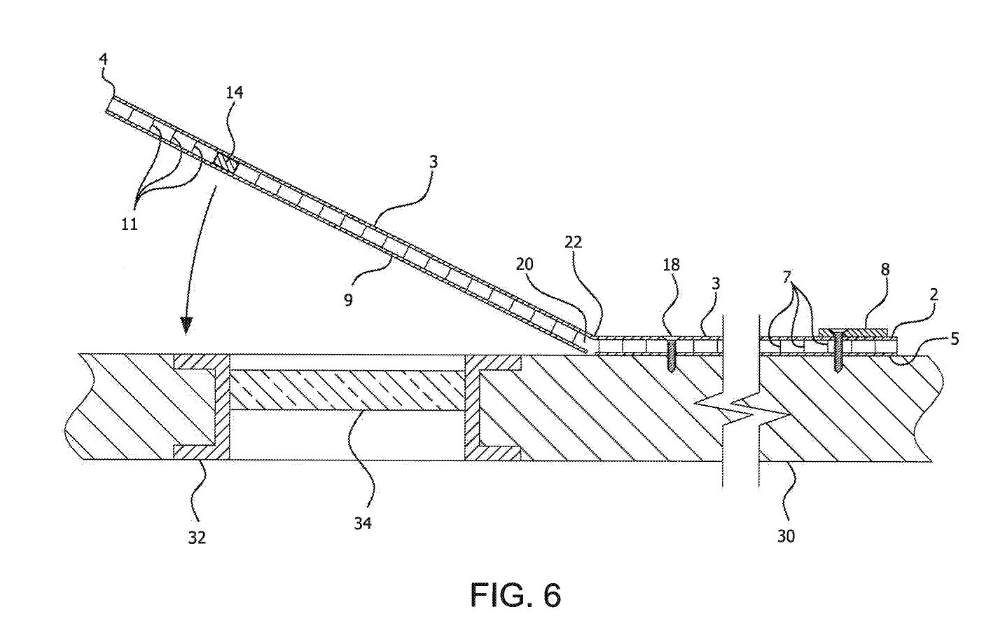

Second section 4 has elongated bottom layer comprising sheet 9 which extends the full length of the section. However, bottom sheet 9 is separate from bottom sheet 5 of first section 2, such that when second section 4 is folded onto the first section in the “window uncovered” position, see especially FIGS. 1 and 6, an elongated channel fold joint 20, extending the full length of the shutter from s top edge to its bottom edge, is formed between the sections, the bottom of the channel joint comprising a small portion 22 of single elongated top sheet 3 of the two sections. When sections 2 and 4 are fully unfolded in the “window cover” position, as seen in FIG. 5, the sections form the single, straight, rectangular-shaped shutter 1, with the two sections lying in the same vertical plane.

Like first section 2, a narrow elongated space separates elongated top sheet 3 and bottom sheet 9 of second section 4 and elongated, corrugated PVC strength ribs 11 extend the length of the section. Encased and secured within ribs 11, near the outboard edge of second section 4, are a plurality of strong magnets 10, 12, and 14. Additional magnets, in different arrangements, can be used as well.

In the “window uncovered” position, in which second section 4 is folded onto first section 2, as shown in FIG. 1, magnets 10 and 14 are attracted to strike plates 6 and 8 on the first section to maintain the sections in the folded position. In the “window covered” position, as shown in FIG. 5, magnets 10, 12, and 14 are attracted to metal window frame 32 around window 34, to maintain the fully opened shutter 1 over the window.

Installation of shutter I itself on door 30 is easily accomplished by the use of screws 16 and 18, which attach first section 2 to the door. Second section 4 is then simply folded over onto first section 2 in the “window uncovered” position, the attraction of strike plates 6 and 8 and magnets 10 and 14 maintaining shutter 1 in this position.

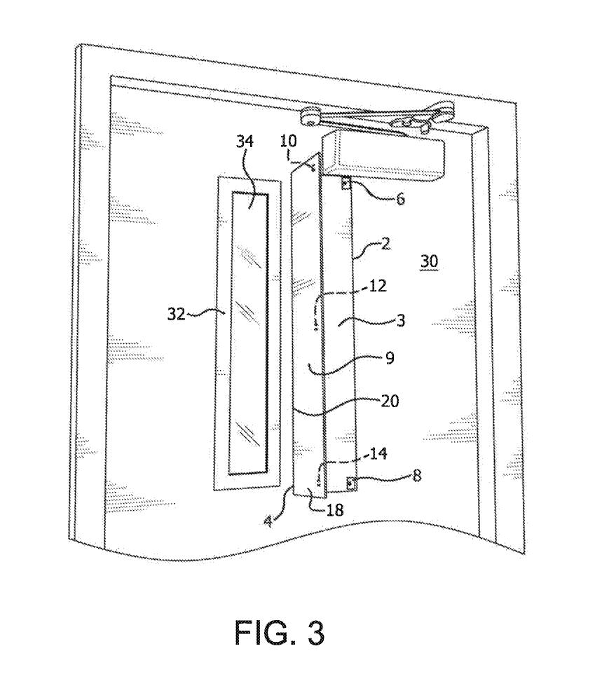

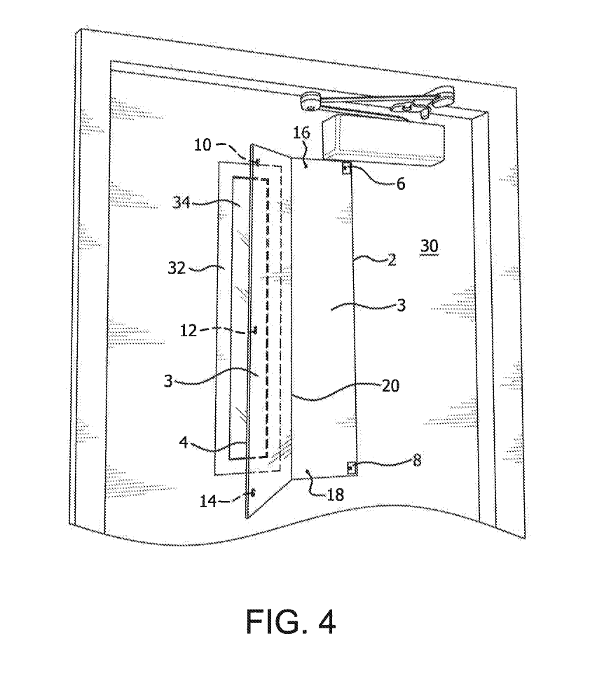

Shutter 1 is put into use by simply lifting second section 4 off first section 2 from the “window uncovered” position, and unfolding it, see FIGS. 3 and 4, so that the full width and length of the shutter covers window 34, see FIG. 5. Magnets 10, 12, and 14 in the second section 4 attach to window frame 32 to maintain shutter 1. in position over the window 34. Window 34 is uncovered by lifting second section 4 off window frame 32 and refolding it onto first section 2.

Certain novel features and components of this invention are disclosed in detail in order to make the invention clear in at least one form thereof, However, it is to be clearly understood that the invention as disclosed is not necessarily limited to the exact form and details as disclosed, since it is apparent that various modifications and changes may be made without departing from the spirit of the invention.

1. A protective window shutter for covering a window, said shutter comprising:
a first shutter section having a vertical length and a horizontal width, said section comprising a top sheet extending the entire vertical length and the entire horizontal width of the section, and at least one metal strike plate secured to the top sheet;
a second shutter section having a vertical length and a horizontal width, said section comprising a bottom sheet extending the entire vertical length and the entire horizontal width of the section, said section further comprising said top sheet Which extends continuously and uninterrupted from the first shutter section, the top sheet extending the entire width and the entire length of the second section, and a space formed between the top sheet and bottom sheet of the second section, the second section further comprising at least one magnet element secured n the space;
whereby the shutter is rotatable from a first position wherein the second se folded onto the first section and attached to the first section by the attraction of said at least one magnet element to the at least one strike plate, to a second position wherein the first and second sections are unfolded and located in the same vertical plane to cover the window.

2. The protective window shutter as in claim 1 wherein the first section comprises a bottom sheet extending the entire width and the entire length of the first section.

3. The protective window shutter as in claim 1 further comprising a joint between the first and second sections, said joint extending the entire length of the shutter.

4. The protective window shutter as in claim 3 wherein when the shutter is in the first position the joint comprises a channel, the bottom of the channel comprising a section of the top sheet.

5. The protective window shutter as in claim 1 further comprising a plurality of strike plates secured to the top sheet of the first section

6. The protective window shutter as in claim 1 further comprising a plurality of magnet elements located within the space of the second section.

7. The protective window shutter as in claim 5 further comprising a plurality of magnetic elements located within the space of the second section.

8. The protective window shutter as in claim 2 wherein a space is formed between the top sheet and the bottom sheet of the first section and said space comprising a plurality of ribs extending the length of the first section.

9. The protective window shutter as in claim 1 wherein the space comprises a plurality of ribs extending the length of the second section.

10. The protective window shutter as in claim 9 wherein a space is formed between the top sheet and the bottom sheet of the first section, said space comprising a plurality of ribs extending the length of the first section.

11. The protective window shutter as in claim 9 Wherein the at least one magnet element is located within the ribs.

12. A protective window shutter system comprising:
a window circumscribed by a metal frame;
a shutter comprising:
a first shutter section having a vertical length and a horizontal width, said section being secured adjacent to the metal frame and having a top sheet extending the entire vertical length and the entire horizontal width of the section, arid at least one metal strike plate secured to the top sheet; and
a second shutter section having a vertical length and a horizontal width, said second section comprising a bottom sheet extending the entire vertical length and the entire horizontal width of the section, said second section further comprising said top sheet Which extends continuously and uninterrupted from the first section, said top sheet extending the entire vertical length and the entire horizontal width of the second section, and a space in the second section between the top sheet and the bottom sheet, the second section further comprising at least one magnet element secured within the space;
whereby the shutter is rotatable from the first position wherein the second section is folded onto the first section and attached to the first section by the attraction of said at least one magnet element to the at least one strike plate, to a second position wherein the first and second sections are unfolded and located in the same vertical plane to cover the window, the shutter being maintained in the second position by the attachment of the at least one magnet element to the metal frame.

13. The protective window shutter as in claim 12 wherein the first section comprises a bottom sheet extending the entire width and the entire length of the first section.

14. The protective window shutter as in claim 12 further comprising a joint between the first and second sections, said joint extending the entire length of the shutter.

15. The protective window shutter as in claim 14 wherein when the shutter is in the first position the joint comprises a channel, the bottom of the channel comprising a section of the top sheet.

16. The protective window shutter as in claim 12 further comprising a plurality of strike plates secured to the top sheet of the first section.

17. The protective window shutter as in claim 12 further comprising a plurality of magnet elements located within the space of the second section.

18. The protective window shutter as in claim 16 further comprising a plurality of magnet elements located within the space of the second section.

19. The protective window shutter as in claim 12 Wherein the space comprises a plurality of ribs extending the length of the second section and a plurality of magnet elements located within the ribs.

20. The protective window shutter as in claim 13 wherein a space is formed between the top sheet and the bottom sheet of the first section, said space comprising a plurality of ribs extending the length of the first section.
